(19) United States
(12) Patent Application Publication
(10) Pub. No.: US 2025/0309548 A1
(43) Pub. Date: Oct. 2, 2025

(54) PASSIVE/ACTIVE ANTENNA SYSTEMS HAVING AN ACTIVE ANTENNA MODULE MOUNTED BEHIND TWO PASSIVE BASE STATION ANTENNAS

(71) Applicant: Outdoor Wireless Networks LLC, Richardson, TX (US)

(72) Inventors: Peter J. Bisiules, LaGrange Park, IL (US); Haifeng Li, Allen, TX (US)

(21) Appl. No.: 19/090,502

(22) Filed: Mar. 26, 2025

Related U.S. Application Data
(60) Provisional application No. 63/570,416, filed on Mar. 27, 2024.

(51) Int. Cl. H01Q 15/00; H01Q 1/24; H01Q 3/30; H01Q 15/14

(52) U.S. Cl. CPC H01Q 15/0013; H01Q 1/246; H01Q 3/30; H01Q 15/14

(57) ABSTRACT

A passive/active antenna system comprises a first passive base station antenna that has a first radome, a second passive base station antenna that has a second radome, the second passive base station antenna mounted adjacent the first passive base station antenna, and an active antenna module mounted behind both the first passive base station antenna and the second passive base station antenna and configured to transmit RF signals through both the first passive base station antenna and the second passive base station antenna.

### CROSS-REFERENCE TO RELATED APPLICATION

The present application claims priority to U.S. Provisional Application Ser. No. 63/570,416, filed Mar. 27, 2024, the entire contents of which is incorporated herein by reference.

### FIELD

The present disclosure relates to communications systems and, in particular, to base station antenna systems for cellular communications systems.

### BACKGROUND

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns of radiating elements or columns in which some of the radiating elements are staggered horizontally to narrow the beamwidths of the generated antenna beams in the azimuth plane. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each array to simultaneously transmit and receive RF signals at two orthogonal polarizations. A dual-polarized radiating element includes a first radiator that transmits and receives RF signals at a first polarization and a second radiator that transmits and receives RF signals at a second (typically orthogonal) polarization.

Each of the above-described linear arrays of dual-polarized radiating elements is coupled to two ports of a radio (one port for each polarization). An RF signal that is to be transmitted by a linear array is passed from the radio to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. Typically these linear arrays will have remote electronic tilt (“RET”) capabilities which allow a cellular operator to change the pointing angle of the generated antenna beams in the elevation (vertical) plane in order to change the size of the sector served by the linear array. Since the antenna beams generated by the above-described 2G/3G/4G lincar arrays generate static antenna beams that only change in shape due to adjustments in the downtilt angle of the antenna beam, they are often referred to as “passive” linear arrays.

Most cellular operators are currently upgrading their networks to support fifth generation (“5G”) cellular service. One important component of 5G cellular service is the use of so-called multi-column “active” beamforming arrays that operate in conjunction with beamforming radios to dynamically adjust the size, shape and pointing direction of the antenna beams that are generated by the active beamforming array. These active beamforming arrays are typically formed using “high-band” radiating elements that operate in higher frequency bands, such as some or all of the 3.3-4.2 GHz and/or the 5.1-5.8 GHz frequency bands. The radiating elements in each column of such an active beamforming array are typically coupled to a respective port of a beamforming radio. The beamforming radio may be a separate device, or may be integrated with the active antenna array. The beamforming radio may adjust the amplitudes and phases of the sub-components of an RF signal that are output at the ports of the radio so that the multi-column beamforming array generates antenna beams that have narrowed beamwidths in the azimuth plane and/or elevation plane (and hence higher antenna gain). These narrowed antenna beams can be electronically steered by proper selection of the amplitudes and phases of the sub-components of the RF signal that are output by the beamforming radio.

In order to avoid having to increase the number of antennas at cell sites, the above-described 5G antennas also often include passive linear arrays that support legacy 2G, 3G and/or 4G cellular services. In some cases, both the active beamforming arrays and the passive linear arrays may be included in a single base station antenna. A second solution for providing an antenna that supports both 2G/3G/4G and 5G cellular service is to mount a 5G active antenna module (i.e., a module that includes an active beamforming array and associated beamforming radio) behind a passive base station antenna that includes a plurality of 2G, 3G, and/or 4G passive linear arrays. With the second solution, an opening is provided in the reflector of the passive base station antenna so that the antenna beams generated by the 5G active beamforming array can be transmitted through the passive base station antenna. This design is advantageous as the active antenna module may be removable, and hence as enhanced 5G capabilities are developed, a cellular operator may initially only deploy the passive base station antenna and add the active antenna modules later, or may replace an originally-deployed active antenna module with an upgraded active antenna module without having to replace the passive base station antenna. Herein, the combination of one or more passive base station antennas and an associated active antenna module that is mounted behind the one or more passive base station antennas is referred to as a “passive/active antenna system.”

FIGS. 1A-1B illustrate a conventional passive/active antenna system 100 that includes both a passive base station antenna 110 and an active antenna module 150. In particular, FIG. 1A is a schematic rear perspective view of the passive/active antenna system 100. FIG. 1B is a schematic perspective view of the passive/active antenna system 100 of FIG. 1A with a radome of the passive base station antenna 110 and a radome and frequency selective surface of the active antenna module 150 omitted. In FIGS. 1A and 1B, the axes illustrate the vertical (V), horizontal (H) and forward (F) directions of the passive/active antenna system 100.

Referring to FIG. 1A, the passive/active antenna system 100 may be mounted, for example, on an antenna tower 102 using mounting hardware 104. The passive/active antenna system 100 includes the passive base station antenna 110 and the active antenna module 150. The active antenna module 150 is mounted behind the passive base station antenna 110. The active antenna module 150 is mounted directly on a rear surface of the passive base station antenna 110, or held in place behind the passive base station antenna 110 by the mounting hardware 104. The passive base station antenna 110 includes a tubular radome 112 that surrounds and protects an antenna assembly that is mounted inside the radome 112. Top and bottom end caps 114, 116 cover the respective top and bottom openings in the radome 112. A plurality of RF ports 118 extend through the bottom end cap 116 and are used to connect the passive base station antenna 110 to one or more external radios (not shown). The active antenna module 150 is removably mounted behind the passive base station antenna 110 so that the active antenna module 150 may later be replaced with a different active antenna module. The active antenna module 150 is referred to as being “associated with” the passive base station antenna 110 because it is mounted directly behind the passive base station antenna 110 and configured to transmit and receive RF signals through the passive base station antenna 110.

Referring to FIG. 1B, the passive base station antenna 110 includes a reflector assembly 120 and a plurality of passive linear arrays of radiating elements that extend forwardly from the reflector assembly 120. The linear arrays comprise respective vertically-extending columns of radiating elements that support, for example, 3G and/or 4G cellular service. In the example passive base station antenna 110 shown in FIGS. 1A-1B, the linear arrays include first and second low-band linear arrays 130-1, 130-2 of low-band radiating elements 132 that are configured to operate in all or part of the 617-960 MHz frequency band, and first through fourth mid-band linear arrays 140-1 through 140-4 of mid-band radiating elements 142 that are configured to operate in all or part of the 1427-2690 MHz frequency band. The low-band and mid-band linear arrays 130, 140 are passive arrays that generate static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the cell).

The reflector assembly 120 includes a main reflector 122 and spaced-apart first and second reflector strips 124-1, 124-2 that extend vertically from respective first and second opposed sides of the main reflector 122. The reflector assembly 120 may further include a third reflector strip 124-3 that extends in the horizontal direction between the first and second reflector strips 124-1, 124-2. The reflector strips 124 may provide structural support. An opening 126 is defined between the first and second reflector strips 124-1, 124-2. For example, the opening 126 may be bounded by a top portion of the main reflector 122, the first and second reflector strips 124-1, 124-2, and the third reflector strip 124-3. Most of the low-band and mid-band radiating elements 132, 142 are mounted to extend forwardly from the main reflector 122. However, low-band linear arrays 130-1, 130-2 and mid-band linear arrays 140-1, 140-4 each extend substantially the full length of the passive/active antenna system 100 and hence extend beyond the main reflector 122. The first and second reflector strips 124-1, 124-2 provide mounting locations for the low-band and mid-band radiating elements 132, 142 that are positioned above the main reflector 122. The first and second reflector strips 124-1, 124-2 may be integral with the main reflector 122 so that the first and second reflector strips 124-1, 124-2 and the main reflector 122 will be maintained at a common ground voltage.

The active antenna module 150 includes a multi-column beamforming array 160 and a beamforming radio (not visible in the figures). The beamforming array 160 may be mounted behind a front radome of the active antenna module 150 (the radome of the active antenna module 150 is omitted in FIG. 1B to show the beamforming array 160), and the beamforming radio may be mounted behind the beamforming array 160. The beamforming array 160 may, for example, comprise a plurality of vertically-extending columns of high-band radiating elements 162 that are configured to operate in all or part of the 3.1-4.2 GHz frequency band. The high-band radiating elements 162 are mounted to extend forwardly from a reflector 154 of the active antenna module 150. The beamforming radio is capable of electronically adjusting the amplitudes and/or phases of the subcomponents of an RF signal that are output to different radiating elements 162 of the multi-column beamforming array 160. For example, each port of the beamforming radio may be coupled to a column of radiators of the beamforming array 160, and the amplitudes and phases of the sub-components of the RF signal that are fed to the radiators in each column may be adjusted so that the generated antenna beam is narrowed in the azimuth plane and pointed in a desired direction in the azimuth plane.

As is shown in FIG. 1B, the beamforming array 160 of active antenna module 150 is mounted behind the opening 126 in the reflector assembly 120. The beamforming array 160 is visible in FIG. 1B as the radomes of both the passive base station antenna 110 and the active antenna module 150 are omitted in the view of FIG. 1B. The opening 126 in the passive reflector assembly 120 is covered by a frequency selective surface 128. The frequency selective surface 128 is also omitted in FIG. 1B to show the beamforming array 160, but a dashed box labeled 128 is included in FIG. 1B to show the location of the frequency selective surface 128. The frequency selective surface 128 acts as a spatial filter that passes, or substantially attenuates and/or reflects RF energy, depending on the frequency of the RF energy. Frequency selective surfaces are known in the art, and typically comprise a grid pattern of unit cells such as a grid pattern of metal patches and/or other metal structures that form resonant circuits. The frequency selective surface 128 may be implemented, for example, as a piece of sheet metal with the grid structure punched or otherwise formed therein or as a dielectric substrate with one or more metal patterns formed therein (such as a printed circuit board). The frequency selective surface 128 may be configured to substantially pass RF energy that is incident thereon in a first frequency range (here the first frequency range may include the operating frequency band of the radiating elements included in the beamforming array 160), while substantially not passing (e.g., reflecting) RF energy that is incident thereon in a second frequency range (here the second frequency range may include the operating frequency bands of the radiating elements included in the passive base station antenna 110). Thus, the frequency selective surface 128 allows the antenna beams generated by the beamforming array 160 to pass through the passive base station antenna 110 and out of the front of the radome 112 of the passive base station antenna 110 to provide service to the coverage area of the passive/active antenna system 100.

SUMMARY

Pursuant to embodiments of the present invention, passive/active antenna systems are provided that comprise a first passive base station antenna that has a first radome, a second passive base station antenna that has a second radome, the second passive base station antenna mounted adjacent the first passive base station antenna, and an active antenna module mounted behind both the first passive base station antenna and the second passive base station antenna and configured to transmit RF signals through both the first passive base station antenna and the second passive base station antenna.

In some embodiments, the first passive base station antenna is horizontally spaced apart from the second passive base station antenna by a gap, and wherein the active antenna module is also configured to transmit RF signals through the gap. In some embodiments, a minimum width of the gap is at least 40 millimeters.

In some embodiments, the active antenna module comprises a multi-column array of radiating elements and a beamforming radio. In some embodiments, the first passive base station antenna has a longitudinal axis that extends substantially in a vertical direction and the first passive base station antenna is spaced apart from the second passive base station antenna in a horizontal direction, the first passive base station antenna includes a frequency selective surface, and the frequency selective surface overlaps at least a first of the columns of radiating elements in a forward direction that is perpendicular to both the vertical direction and the horizontal direction.

In some embodiments, the active antenna module and the first and second passive base station antennas are mounted on a mounting structure using shared mounting hardware. In some embodiments, the active antenna module is positioned within 50 millimeters of both the first passive base station antenna and the second passive base station antenna.

In some embodiments, the active antenna module overlaps the first passive base station antenna in a forward direction that is perpendicular to a plane defined by a main reflector of the first passive base station antenna, and the active antenna module overlaps the second passive base station antenna in the forward direction.

In some embodiments, the first passive base station antenna comprises a first reflector, a first frequency selective surface mounted above the first reflector, and a first plurality of lower-band radiating elements that form a first lower-band array, where a first subset of the first plurality of lower-band radiating elements extend forwardly of the first reflector and a second subset of the first plurality of lower-band radiating elements extend forwardly of the first frequency selective surface. In such embodiments the second passive base station antenna may comprise second reflector, a second frequency selective surface mounted above the second reflector, and a second plurality of lower-band radiating elements that form a second lower-band array, where a first subset of the second plurality of lower-band radiating elements extend forwardly of the second reflector and a second subset of the second plurality of lower-band radiating elements extend forwardly of the second frequency selective surface. In such embodiments, the first and second subsets of the first plurality of lower-band radiating elements extend along a first axis, and the first passive base station antenna further comprises a plurality of higher-band radiating elements that extend along the first axis. In some embodiments, the active antenna module may include a multi-column array of intermediate-band radiating elements, the multi-column array configured to transmit RF signals through both the first passive base station antenna and the second passive base station antenna, where each intermediate-band radiating element has an operating frequency band that is above an operating frequency band of the lower-band radiating elements and that is below an operating frequency band of the higher-band radiating elements. In some embodiments, the first frequency selective service may be mounted on a metal support that includes a meta-surface that is substantially transparent to RF energy in the operating frequency band of the intermediate-band radiating elements. In other embodiments, the first frequency selective service may be mounted on a first pair of non-metallic supports and the second frequency selective service is mounted on a second pair of non-metallic supports.

In some embodiments, the first and second passive base station antennas are configured to be mounted on a mounting structure, and the active antenna module is configured to be mounted between the first and second passive base station antennas and the mounting structure.

Pursuant to further embodiments of the present invention, passive/active antenna systems are provided that comprise a first passive base station antenna that has a first housing that includes a first radome, a second passive base station antenna that has a second housing that includes a second radome mounted adjacent the first passive base station antenna and spaced apart from the first passive base station antenna in a horizontal direction by a gap, and an active antenna module having a multi-column array of radiating elements mounted so that a first column of radiating elements of the multi-column array is behind the first passive base station antenna, a second column of radiating elements of the multi-column array is behind the second passive base station antenna, and a third column of radiating elements of the multi-column array is at least partly behind the gap.

In some embodiments, the first and second passive base station antennas are configured to be mounted on a mounting structure, and the active antenna module is configured to be mounted between the first and second passive base station antennas and the mounting structure.

In some embodiments, the active antenna module is configured to transmit RF signals through the first passive base station antenna, the second passive base station antenna, and the gap.

In some embodiments, a minimum width of the gap in the horizontal direction is between 20 millimeters and 200 millimeters.

In some embodiments, the first passive base station antenna includes a frequency selective surface, and the frequency selective surface overlaps the first column of radiating elements of the multi-column array in a forward direction that is perpendicular to both a vertical direction and the horizontal direction. In some embodiments, the first frequency selective service is mounted on a metal support that includes a meta-surface that is substantially transparent to RF energy in an operating frequency band of the multi-column array of radiating elements. In some embodiments, the first frequency selective service is mounted on a first pair of non-metallic supports and the second frequency selective service is mounted on a second pair of non-metallic supports.

In some embodiments, the active antenna module is positioned within 50 millimeters of both the first passive base station antenna and the second passive base station antenna.

Pursuant to additional embodiments of the present invention, passive/active antenna systems are provided that comprise a first passive base station antenna that has a first radome that has a first inner side and a first outer side opposite the first inner side, a second passive base station antenna that has a second radome that has a second inner side and a second outer side opposite the second inner side, the second base station antenna mounted adjacent the first passive base station antenna in a horizontal direction so that the second inner side is adjacent the first inner side, and an active antenna module having a multi-column array of radiating elements mounted behind both the first passive base station antenna and the second passive base station antenna. The first passive base station antenna includes a first frequency selective surface that extends closer to the first inner side than it does to the first outer side, and the second passive base station antenna includes a second frequency selective surface that extends closer to the second inner side than it does to the second outer side.

In some embodiments, the first passive base station antenna is spaced apart from the second passive base station antenna by a gap of at least 20 millimeters.

In some embodiments, the active antenna module is configured to transmit RF signals through the first frequency selective surface, through the second frequency selective surface, and through the gap.

In some embodiments, a longitudinal axis of the first passive base station antenna extends substantially in a vertical direction and the first passive base station antenna is spaced apart from the second passive base station antenna in the horizontal direction, and the first frequency selective surface overlaps at least a first of the columns of radiating elements in the multi-column array in a forward direction that is perpendicular to both the vertical direction and the horizontal direction, and the second frequency selective surface overlaps at least a second of the columns of radiating elements in the multi-column array in the forward direction.

In some embodiments, at least a third of the columns of radiating elements in the multi-column array overlaps the gap in the forward direction.

In some embodiments, the first and second passive base station antennas are configured to be mounted on a mounting structure, and the active antenna module is configured to be mounted between the first and second passive base station antennas and the mounting structure.

Pursuant to yet additional embodiments of the present invention, a first passive base station antenna that comprises a reflector, a frequency selective surface mounted above the reflector, a plurality of lower-band radiating elements that form a lower-band array, where a first subset of the lower-band radiating elements extend forwardly of the reflector and a second subset of the lower-band radiating elements extend forwardly of the frequency selective surface, a plurality of higher-band radiating elements that form a higher-band array, where all of the higher-band radiating elements extend forwardly of the reflector, and a first radome. The passive/active antenna system further comprises a second passive base station antenna that has a second radome, the second passive base station antenna mounted adjacent the first passive base station antenna, and an active antenna module having a multi-column array of intermediate-band radiating elements mounted so that a first column of intermediate-band radiating elements of the multi-column array is behind the first passive base station antenna and a second column of intermediate-band radiating elements of the multi-column array is behind the second passive base station antenna. A center frequency of an operating frequency band of the intermediate-band radiating elements is between a center frequency of an operating frequency band of the lower-band radiating elements and a center frequency of an operating frequency band of the higher-band radiating elements.

In some embodiments, the lower-band radiating elements extend in a first column along a first axis and the intermediate-band radiating elements extend in a second column along the first axis.

In some embodiments, the lower-band radiating elements extend in a first column so that first sides of the lower-band radiating elements extend along a first longitudinal axis and second sides of the lower-band radiating elements extend along a second longitudinal axis that is parallel to the first longitudinal axis, and the intermediate-band radiating elements are positioned in between the first and second longitudinal axes.

In some embodiments, the second passive base station antenna is spaced apart from the first passive base station antenna by a gap. In some embodiments, a third column of intermediate-band radiating elements of the multi-column array is behind the gap. In some embodiments, a minimum width of the gap in a horizontal direction is at least 40 millimeters.

In some embodiments, the first and second passive base station antennas are mounted on a mounting structure via a first antenna bracket that attaches to an upper mounting plate on the first passive base station antenna and to an upper mounting plate on the second passive base station antenna. In some embodiments, the first and second passive base station antennas are also mounted on the mounting structure via a second antenna bracket that attaches to a lower mounting plate on the first passive base station antenna and to a lower mounting plate on the second passive base station antenna. In some embodiments, the active antenna module is mounted on the first antenna bracket. In some embodiments, the active antenna module is slidably received on the first antenna bracket.

Pursuant to another aspect of the present invention, a A method of mounting a base station antenna system on an antenna mounting structure is provided in which a shared upper mounting plate is attached to a first upper mounting plate on a first base station antenna and to a second upper mounting plate on a second base station antenna. Similarly, a shared lower mounting plate is attached to a first lower mounting plate on the first base station antenna and to a second lower mounting plate on the second base station antenna. The first base station antenna and the second base station antenna are mounted on the mounting structure via at least a first antenna mounting bracket. An active antenna module is mounted in a mounting frame. The mounting frame is slid onto the antenna mounting bracket to position the active antenna module behind the first and second base station antennas.

The method may further comprise fixing the active antenna module to the antenna mounting bracket.

In some embodiments, the active antenna module is configured to transmit RF signals through both the first base station antenna and the second base station antenna.

In some embodiments, the first base station antenna is spaced apart from the second base station antenna in a horizontal direction by a gap, and wherein the active antenna module is also configured to transmit RF signals through the gap. In some embodiments, a minimum width of the gap in the horizontal direction is at least 40 millimeters.

### BRIEF DESCRIPTION OF THE DRAWINGS

FIG. 1A is a schematic rear perspective view of a conventional passive/active antenna system that comprises a passive base station antenna and an associated active antenna module.

FIG. 1B is a schematic perspective view of the conventional passive/active antenna system of FIG. 1A with the radome of the passive base station antenna and the radome and a frequency selective surface of the active antenna module omitted.

FIG. 2A is a schematic perspective view illustrating how a cellular operator can mount first and second conventional passive base station antennas on an antenna tower using a single antenna mounting kit.

FIG. 2B is a schematic front view of one of the conventional base station antennas of FIG. 2A with the radome thereof removed.

FIGS. 3A-3C are a perspective front view, a perspective rear view and a front view, respectively, of a passive/active antenna system according to embodiments of the present invention.

FIG. 3D is a schematic bottom view of the passive/active antenna system of FIGS. 3A-3C.

FIG. 3E is a schematic front view of the active antenna module included in the passive/active antenna system of FIGS. 3A-3D with the radome of the active antenna module omitted.

FIG. 3F is a schematic front view of the passive/active antenna system of FIGS. 3A-3D with the radomes of the two passive base station antennas omitted.

FIGS. 4A-4C are a perspective front view, a perspective rear view and a front view, respectively, of a passive/active antenna system according to further embodiments of the present invention.

FIG. 4D is a schematic bottom view of the passive/active antenna system of FIGS. 4A-4C.

FIG. 4E is a schematic front view of the passive/active antenna system of FIGS. 4A-4D with the radomes of the two passive base station antennas omitted.

FIG. 5 is a schematic front view of a passive/active antenna system according to further embodiments of the present invention with the radomes of the two passive base station antennas omitted.

FIGS. 6A-6G are various views illustrating how a passive/active antenna system according to embodiments of the present invention may be mounted on an antenna tower with the active antenna module mounted on the antenna mounting brackets.

FIG. 7 is a schematic front view of a passive/active antenna system according to still further embodiments of the present invention with the radomes of the two passive base station antennas omitted.

### DETAILED DESCRIPTION

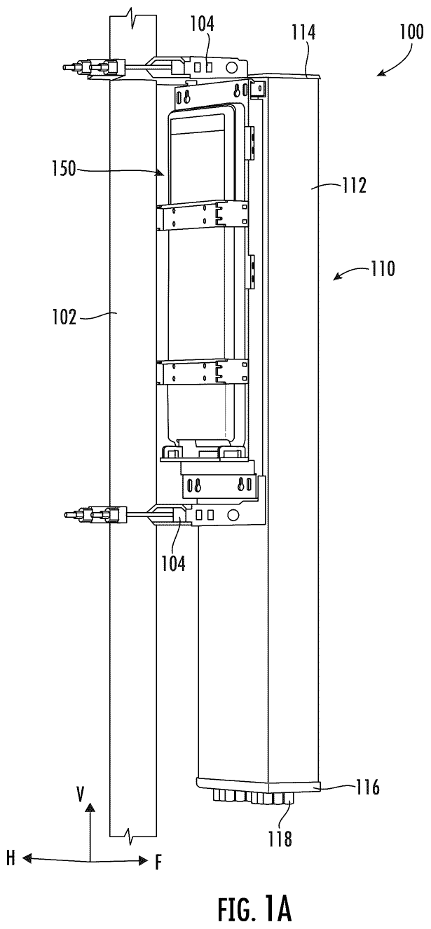

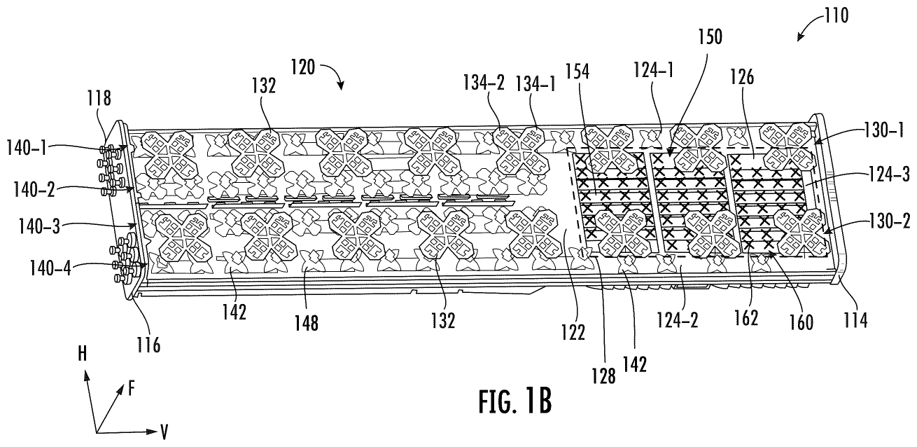

While the passive/active antenna system 100 of FIGS. 1A-1B is gaining increasing popularity as it reduces the antenna count at a cell site, some cellular operators prefer deploying a larger number of base station antennas where each base station antenna includes fewer arrays of radiating elements for redundancy purposes. For example, instead of deploying a passive base station antenna that includes two linear arrays of low-band radiating elements and four linear arrays of mid-band radiating elements, some cellular operators will instead deploy two passive base station antennas that each include a single linear array of low-band radiating elements and two linear arrays of mid-band radiating elements. These two antennas are typically mounted side-by-side on an antenna tower or other mounting structure, often using shared mounting hardware. As such, remote radio heads can be connected to both antennas, if desired, to allow the linear arrays in both antennas be used to support, for example, upper order MIMO operations (e.g., two ports of a remote radio head may be coupled to the low-band linear array in the first of the antennas while two additional ports of the remote radio head may be coupled to the low-band linear array in the second of the antennas so that the two antennas are used to support 4×MIMO operations in the low-band frequency range). Deploying two smaller base station antennas instead of one larger base station antenna may be advantageous because if the larger base station antenna malfunctions, cellular service may be completely lost, whereas if two smaller base station antennas are deployed, loss of one antenna will not result in a complete outage.

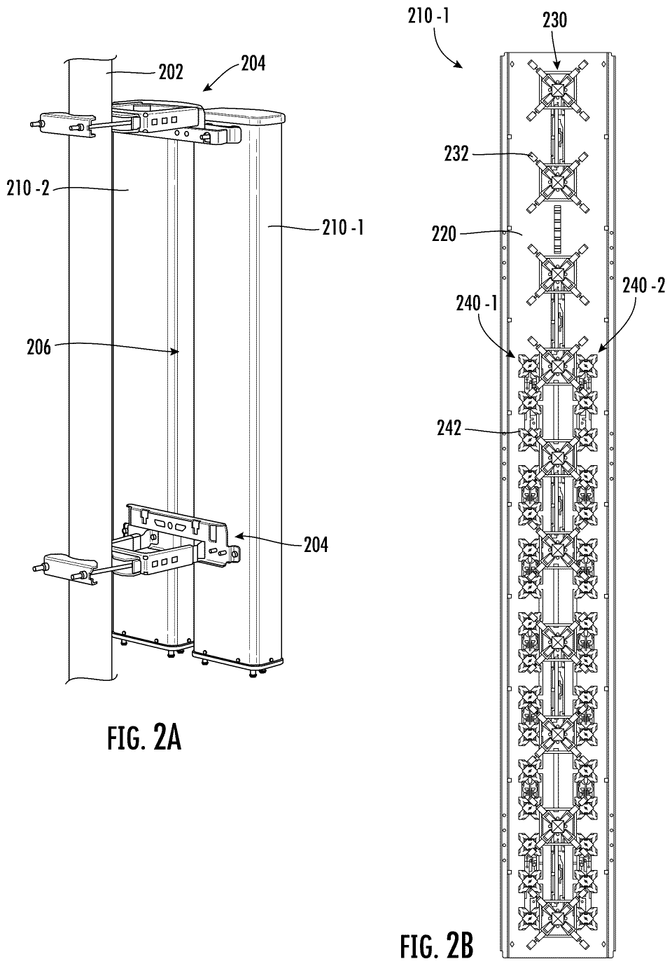

FIG. 2A illustrates an antenna tower 202 having first and second passive base station antennas 210-1, 210-2 mounted thereon, where both passive base station antennas 210-1, 210-2 are operated by the same cellular network operator. As shown in FIG. 2A, a single antenna mounting kit 204 is used to mount both passive base station antennas 210-1, 210-2 on the antenna tower 202. The first and second passive base station antennas 210-1, 210-2 are mounted side-by-side with a small horizontal gap 206 therebetween.

FIG. 2B is a schematic front view of the first passive base station antenna 210-1 with the radome thereof removed. The second passive base station antenna 210-2 may be identical to the first passive base station antenna 210-1. As shown, the passive base station antenna 210-1 includes a linear array 230 of low-band radiating elements 232 (also referred to herein as low-band linear array 230) that extends longitudinally down the middle of a reflector 220, and first and second linear arrays 240-1, 240-2 of mid-band radiating elements 242 (also referred to herein as mid-band linear arrays 240-1, 240-2) that extend longitudinally down the reflector 220 on either side of the low-band array 230. In some cases, each of the two passive base station antennas 210-1, 210-2 may further include a linear array of high-band radiating elements (not shown) that may, for example, provide service in the CBRS frequency band (3.5-3.7 GHZ). As the first and second passive base station antennas 210-1, 210-2 only include a single low-band array 230, these antennas are relatively narrow, typically having a width of about 300 mm.

As discussed above, cellular operators are now deploying 5G antennas that include multi-column beamforming arrays, either in the high-band frequency range or in the upper portion of the mid-band frequency range (e.g., the 2.5-2.7 GHz frequency range). In order to reduce costs and antenna counts, most cellular operators prefer to deploy at least some of these 5G antennas using active antenna modules that are deployed in passive/active antenna systems such as the passive/active antenna system 100 of FIGS. 1A-1B above. The multi-column beamforming arrays in the active antenna modules of such passive/active antenna systems typically include at least eight columns of radiating elements. As can best be seen in FIG. 1A, even when relatively small high-band radiating elements are used in the multi-column beamforming array, the active antenna module is still fairly wide, and usually has a width of more than 400 mm. As such, an active antenna module cannot readily be mounted on a narrow passive base station antenna such as antennas 210-1, 210-2 of FIGS. 2A-2B since the active antenna module is wider than the passive base station antenna.

Pursuant to embodiments of the present invention, passive/active antenna systems are provided which include an active antenna module that is mounted directly behind a pair of passive base station antennas and configured to transmit RF signals through both of the passive base station antennas. The active antenna module may, for example, be mounted directly on the two passive base station antennas and/or mounted on an antenna mounting bracket that is used to mount the two antennas on an antenna tower or other mounting structure. The active antenna module may include a multi-column array of radiating elements therein that includes, for example, eight columns of radiating elements. At least a first of these columns of radiating elements may be positioned directly behind and overlapping the first passive base station antenna, at least a second of the columns of radiating elements may be positioned directly behind and overlapping the second passive base station antenna, and at least a third of the columns of radiating elements may be positioned at least partly behind the gap. A column of radiating elements in a multi-column beamforming array “overlaps” an associated passive base station antenna if an axis that is perpendicular to a reflector of the passive base station antenna extends through both the passive base station antenna and the column of radiating elements.

The two passive base station antennas may be designed so that selected portions thereof are substantially transparent to RF energy in the operating frequency band of the multi-column array of radiating elements. Consequently, the multi-column array of radiating elements may transmit and receive RF signals through the two passive base station antennas. For example, portions of the reflectors of the two passive base station antennas may be replaced with frequency selective surfaces that are designed to substantially pass RF energy in, for example, the high-band frequency range while substantially reflecting RF energy in, for example, the low-band frequency range (and perhaps the mid-band frequency range as well).

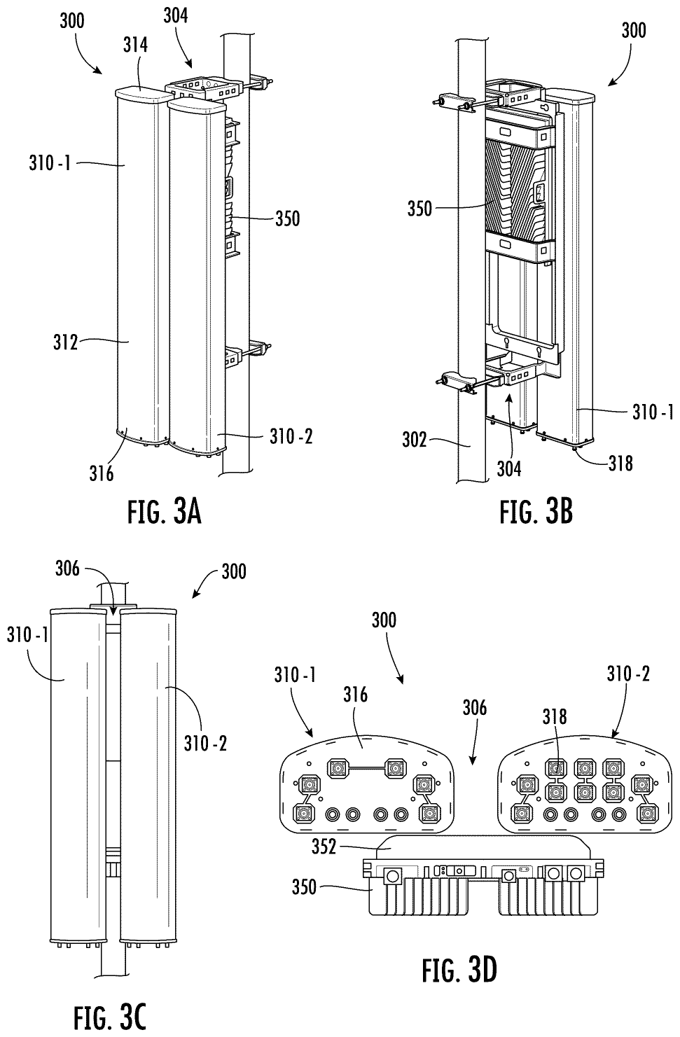

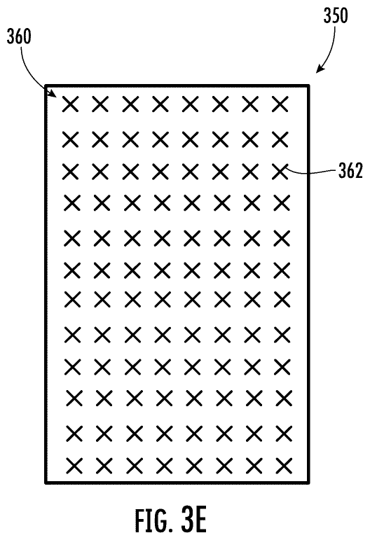

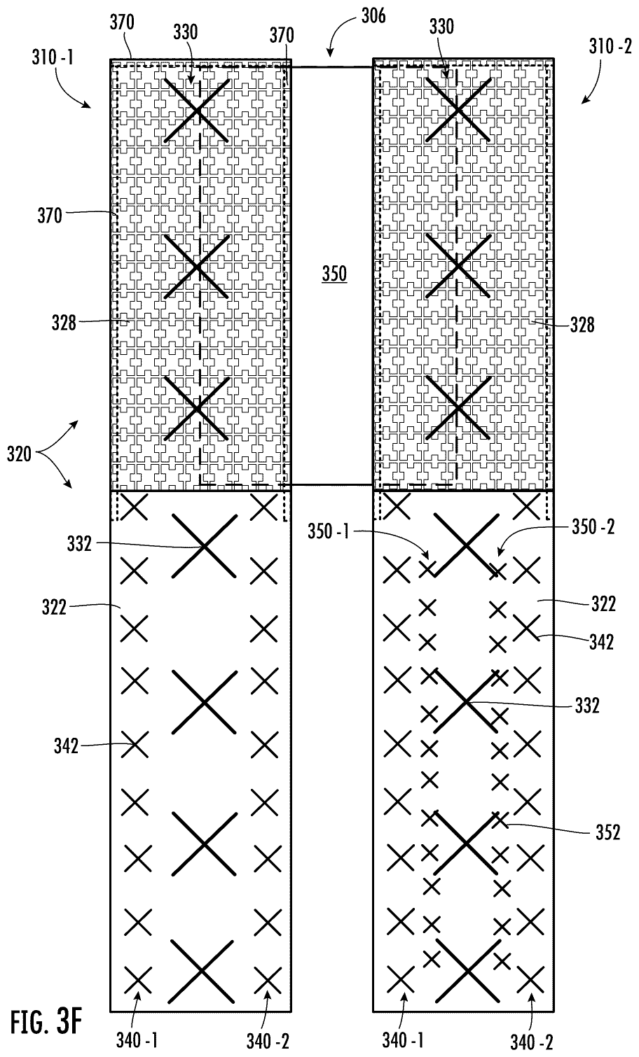

Passive/active antenna systems according to embodiments of the present invention will now be discussed in more detail with reference to FIGS. 3A-7.

FIGS. 3A-3C are a perspective front view, a perspective rear view and a front view, respectively, of a passive/active antenna system 300 according to embodiments of the present invention. FIG. 3D is a schematic bottom view of the passive/active antenna system of FIGS. 3A-3C. As shown in in FIGS. 3A-3D, the passive/active antenna system 300 includes a first passive base station antenna 310-1, a second passive base station antenna 310-2, and an active antenna module 350. The first and second passive base station antenna 310-1, 310-2 are mounted in side-by-side fashion with a small horizontal gap 306 therebetween. The gap 306 may have a minimum width of, for example, 20 millimeters or 40 millimeters. In some embodiments, the minimum width of the gap 306 may be between 20 millimeters and 200 millimeters. The passive/active antenna system 300 is mounted on an antenna tower 302 using mounting hardware 304 such as upper and lower antenna mounting brackets. The active antenna module 350 is mounted directly behind the first and second passive base station antennas 310-1, 310-2. For example, in some embodiments, the active antenna module 350 may be positioned within 50 millimeters or less of both the first and second passive base station antennas 310-1, 310-2. The active antenna module 350 may be mounted directly on the rear surfaces of the passive base station antennas 310-1, 310-2, and/or may be mounted on the mounting hardware 304 that is used to mount the two passive base station antennas 310 on the antenna tower 302 (or other structure).

Each passive base station antenna 310 includes a tubular radome 312, a top end cap 314, and a bottom end cap 316 that together form a housing for the antenna. A plurality of RF ports 318 extend through the bottom end cap 316 and are used to connect the passive base station antennas 310 to one or more external radios (not shown). The active antenna module 350 is removably mounted directly behind the two passive base station antennas 310-1, 310-2, and as such, the active antenna module 350 may later be replaced with a different active antenna module, preferably while the two passive base station antennas 310 remain mounted on the antenna tower 302.

FIG. 3E is a schematic front view of the active antenna module 350 included in the passive/active antenna system 300 of FIGS. 3A-3D. Referring to FIG. 3E, the active antenna module 350 includes a multi-column beamforming array 360 that includes multiple columns of high-band radiating elements 362. A radome 352 (FIG. 3D) covers and protects the radiating elements 362. The beamforming array 360 includes eight columns of high-band radiating elements 362 that are configured to operate in, for example, some or all of the 3.1-4.2 GHz frequency band. The active antenna module 350 further includes a beamforming radio (not visible in the figures) that is positioned rearwardly of the multi-column beamforming array 360. The beamforming radio is capable of electronically adjusting the amplitudes and/or phases of the subcomponents of an RF signal that are output to different radiating elements 362 of the multi-column beamforming array 360. For example, each port of the beamforming radio may be coupled to a column of radiators of the beamforming array 360, and the amplitudes and phases of the sub-components of the RF signal that are fed to the radiators in each column may be adjusted so that the generated antenna beam is narrowed in the azimuth plane and pointed in a desired direction in the azimuth plane.

FIG. 3F is a schematic front view of the first and second passive base station antennas 310-1, 310-2 with the radomes 312 thereof omitted. As shown in to FIG. 3F, the first passive base station antenna 310-1 includes a reflector assembly 320 that includes a main reflector 322 and a frequency selective surface 328 that is mounted above the main reflector 322. A plurality of low-band radiating elements 332 are mounted to extend forwardly from the main reflector 322 to form a low-band linear array 330 that operates in all or part of the 617-960 MHz frequency band. The first passive base station antenna 310-1 further includes first and second mid-band linear arrays 340-1, 340-2 that are configured to operate in all or part of the 1427-2690 MHz frequency band. Each mid-band linear array 340 comprises a vertically-extending column of mid-band radiating elements 342. The two mid-band linear arrays 340-1, 340-2 are mounted on each side of the low-band linear array 330. Each of the low-band and mid-band linear arrays 330, 340 are passive linear arrays that generate static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the cell).

The low-band and mid-band radiating elements 332, 342 may be implemented as dual-polarized radiating elements that include first and second radiators that transmit and receive RF energy at orthogonal polarizations, such as slant −45°/+45° cross-dipole radiating elements. When such dual-polarized radiating elements are used, each of the linear arrays 330, 340 may be connected to a pair of ports of a radio through a pair of the RF ports 318.

The passive reflector assembly 320 includes the main reflector 322 that forms the lower portion of the passive reflector assembly 320 and the frequency selective surface 328 that is mounted above the main reflector 322. The frequency selective surface 328 is configured to substantially pass RF energy that is incident thereon in a first frequency range, while partially or substantially not passing (e.g., reflecting) RF energy that is incident thereon in a second frequency range (here the second frequency range may include at least the low-band frequency range).

The low-band linear array 330 extends longitudinally down the center of the antenna 310-1 with some of the low-band radiating elements 332 mounted to extend forwardly from the main reflector 322 and the remainder of the low-band radiating elements 332 mounted to extend forwardly from the frequency selective surface 328. The mid-band linear arrays 340 extend on each side of the lower portion of the low-band linear array 330. Since only a relatively small number of mid-band radiating elements are included in each mid-band linear array 340, all of the mid-band radiating elements 342 are mounted to extend forwardly from the main reflector 322. The frequency selective surface 328 is configured to substantially pass RF energy that is incident thereon in the operating frequency band of the high-band radiating elements that are included in the multi-column array 360 in active antenna module 350, while substantially reflecting RF energy that is incident thereon in the operating frequency band of the low-band radiating elements 332.

While in the depicted embodiment, the three uppermost low-band radiating elements are mounted directly on the frequency selective surface, it will be appreciated that embodiments of the present invention are not limited thereto. For example, in other embodiments, tilt stalk low-band radiating elements such as the radiating elements disclosed in U.S. Pat. No. 11,652,300 may be used to implement the low-band radiating elements 332 that are mounted forwardly of the frequency selective surface 328. The base of the feed stalks of these radiating elements may be mounted on, for example, plastic rails that extend along one or both sides of the antenna adjacent the frequency selective surface 328.

A plurality of structural supports 370 may be provided that are used to hold the frequency selective surface 328 in place above the main reflector 322. The structural supports 370 may be metal rods, bars or the like or instead can be formed of plastic. If metal supports are used, the supports may optionally be cloaked using metamaterials to render these structures substantially transparent to RF signals in the operating frequency band of the beamforming array included in the active antenna module 350. The supports 370 may be mounted rearwardly and/or forwardly of the main reflector 322 and/or the frequency selective surface 328. The supports 370 are shown schematically in FIG. 3F using dotted rectangles. It will also be appreciated that in further embodiments the frequency selective surfaces 328 may be mounted on dielectric matching layers that are included in the passive base station antennas 310. In fact, in some cases, the frequency selective surfaces 328 may be implemented by printing metal patters onto the dielectric matching layers. The dielectric matching layers may be configured to reduce the extent to which RF energy emitted by the beamforming array is reflected by the radome of the passive base station antennas 310.

The second passive base station antenna 310-2 may be identical to the first passive base station antenna 310-1, except that passive base station antenna 310-2 further includes first and second high-band linear arrays 340-1, 340-2 that are configured to operate in, for example, the 3.55-3.7 GHz frequency band. Each high-band linear array 340 comprises a vertically-extending column of high-band radiating elements 342. The high-band linear arrays 340 are passive linear arrays that generate static antenna beams that provide coverage to a predefined coverage area (e.g., antenna beams that are each configured to cover a sector of a base station).

The active antenna module 350 is partially visible in FIG. 3F (through the gap 306). The portions of the active antenna module 350 that overlap the first and second passive base station antennas 310-1, 310-2 are illustrated using dashed lines, while the portion of the active antenna module 350 that is visible through the gap 306 between the first and second passive base station antennas 310-1, 310-2 is shown using solid lines. As can be seen, the active antenna module (or at least the portion of the active antenna module 350 that includes the beamforming array 360) is mounted directly behind the frequency selective surfaces 328 of the first and second passive base station antennas 310-1, 310-2 and behind the gap 306. Consequently, the beamforming array 360 transmits and receives RF signals through the first and second passive base station antennas 310-1, 310-2 and through the gap 306.

Referring to FIGS. 3A-3F, the passive/active antenna system 300 includes a first passive base station antenna 310-1 that has a first radome 312, a second passive base station antenna 310-1 that has a second radome 312, and an active antenna module 350 that is mounted behind both the first and second passive base station antennas 310-1, 310-2 and configured to transmit RF signals through both the first and second passive base station antennas 310-1, 310-2. The active antenna module 350 comprises a multi-column array 360 of radiating elements 362 and may also include a beamforming radio. The first passive base station antenna 310-1 is spaced apart from the second passive base station antenna 310-2 in a horizontal direction by a gap 306. The active antenna module 350 is also configured to transmit RF signals through the gap 306. The active antenna module 350 is mounted so that a first column of radiating elements of the multi-column array 360 is behind the first passive base station antenna 310-1, a second column of radiating elements of the multi-column array 360 is behind the second passive base station antenna 310-2, and a third column of radiating elements of the multi-column array is at least partly behind the gap 306.

The first and second passive base station antennas 310-1, 310-2 are mounted on a mounting structure such as an antenna tower 302, and the active antenna module 350 is mounted in between the first and second passive base station antennas 310-1, 310-2 and the mounting structure 302. The active antenna module 350 may, for example, be mounted within 50 millimeters of both the first passive base station antenna 310-1 and the second passive base station antenna 310-2. The active antenna module 350 and the first and second passive base station antennas 310-1, 310-2 may be mounted using shared mounting hardware 304. The active antenna module 350 is mounted so that it overlaps the first passive base station antenna 310-1 in a forward direction that is perpendicular to a plane defined by a main reflector 322 of the first passive base station antenna 310-1, and the active antenna module 350 also overlaps the second passive base station antenna 310-2 in the forward direction.

The first passive base station antenna 310-1 comprises a first reflector 322, a first frequency selective surface 328 that is mounted above the first reflector 322, and a first plurality of lower-band radiating elements 332 that form a first lower-band array 330, where a first subset of the first plurality of lower-band radiating elements 332 extend forwardly of the first reflector 322 and a second subset of the first plurality of lower-band radiating elements 332 extend forwardly of the first frequency selective surface 328. Similarly, the second passive base station antenna 310-2 comprises a second reflector 322, a second frequency selective surface 328 that is mounted above the second reflector 322, and a second plurality of lower-band radiating elements 332 that form a second lower-band array 330, where a first subset of the second plurality of lower-band radiating elements 332 extend forwardly of the second reflector 322 and a second subset of the second plurality of lower-band radiating elements 332 extend forwardly of the second frequency selective surface 328. The first frequency selective service 328 may be mounted on, for example, a metal support 370 that includes a meta-surface that is substantially transparent to RF energy in the operating frequency band of the radiating elements 362 of the multi-column array 360 or on one or more non-metallic supports 370.

Cellular operators are now deploying base station antennas having multicolumn beamforming arrays that operate in the upper portion of the mid-band frequency range (i.e., mid-band beamforming arrays). For example, there is demand for base station antennas that include multicolumn beamforming arrays that operate in the 2.5-2.7 GHz frequency band. Pursuant to further embodiments of the present invention, passive/active base station antenna systems are provided that include first and second passive base station antennas and an associated active antenna module that includes a multi-column beamforming array of mid-band radiating elements.

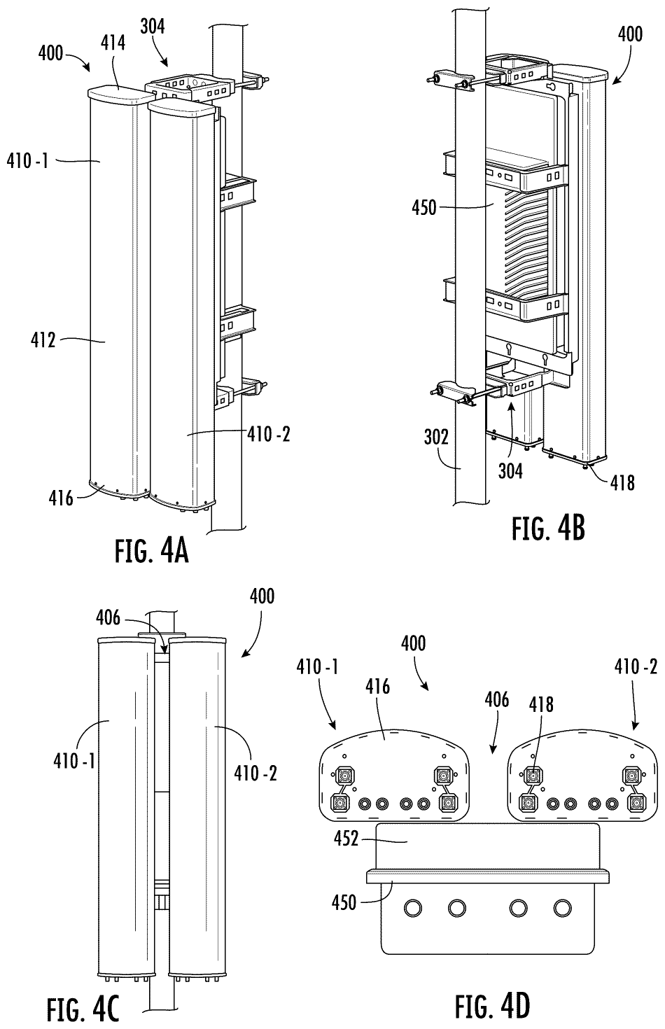

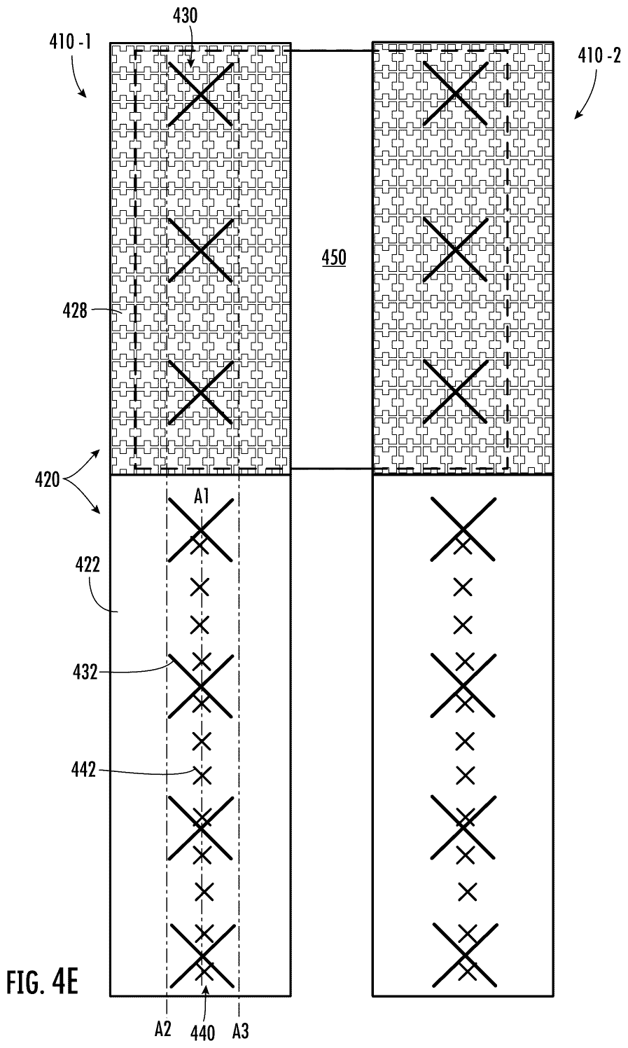

FIGS. 4A-4C are a perspective front view, a perspective rear view and a front view, respectively, of a passive/active antenna system 400 according to further embodiments of the present invention. FIG. 4D is a schematic bottom view of the passive/active antenna system 400 of FIGS. 4A-4C. As shown in in FIGS. 4A-4D, the passive/active antenna system 400 includes a first passive base station antenna 410-1, a second passive base station antenna 410-2, and an active antenna module 450. The first and second passive base station antenna 410-1, 410-2 are mounted in side-by-side fashion with a small horizontal gap 406 therebetween. The gap 406 may have a minimum width of, for example, 20 millimeters. The passive/active antenna system 400 is mounted on an antenna tower 302 using mounting hardware 304 such as upper and lower antenna mounting brackets in the same manner as passive/active antenna system 300, and hence further description of the mounting configuration will be omitted. Each passive base station antenna 410 includes a tubular radome 412, a top end cap 414, and a bottom end cap 416 that together form a housing. A plurality of RF ports 418 extend through the bottom end cap 416. The active antenna module 450 is removably mounted directly behind the two passive base station antennas 410-1, 410-2. As can be seen by comparing FIGS. 4A-4D with FIGS. 3A-3D, the passive/active antenna system 400 may, from the outside, appear identical to the passive/active antenna system 300 except that the active antenna module 450 has a different size and shape as compared to active antenna module 350. The active antenna module 450 is similar to active antenna module 350 (FIG. 3E), except that active antenna module 450 includes eight columns of mid-band radiating elements instead of eight columns of high-band radiating elements, and includes a mid-band beamforming radio instead of a high-band beamforming radio.

FIG. 4E is a schematic front view of the first and second passive base station antennas 410-1, 410-2 with the radomes 412 thereof omitted. As shown in to FIG. 4E, the first passive base station antenna 410-1 includes a reflector assembly 420 that includes a main reflector 422 and a frequency selective surface 428 that is mounted above the main reflector 422. The reflector assembly 420 may be identical to the reflector assembly 320 of FIG. 3F, and hence further description thereof will be omitted. A plurality of low-band radiating elements 432 are mounted to extend forwardly from the main reflector 422 to form a low-band linear array 430 that may be identical to low-band linear array 330 of FIG. 3F. The first passive base station antenna 410-1 further includes a high-band linear array 440 that comprises a column of high-band radiating elements 442 that are each configured to operate in, for example, the 3.55-3.7 GHz frequency band. The high-band radiating elements 442 all extend forwardly from the main reflector 422 so that the high-band linear array 440 does not extend in front of the frequency selective surface 428. The high-band linear array 440 is a passive linear array that generates static antenna beams that provide coverage to a predefined coverage area. While not shown in FIG. 4E, the first passive base station antenna may include the structural supports 370 discussed above with reference to FIG. 3F. The second passive base station antenna 410-2 may be identical to the first passive base station antenna 410-1, and hence description thereof will be omitted.

The passive/active antenna system 400 allows a cellular operator to provide service in the low-band, mid-band and high-band frequency ranges using a single passive/active antenna system. The mid-band service is provided solely by the active antenna module 450, and hence no mid-band linear arrays are included in the passive base station antennas 410-1, 410-2. In the depicted embodiment, the high-band linear array 440 in each passive base station antenna 410 may be mounted along a vertically-extending axis, and the low-band linear array 430 in each antenna may extend along the same axis. In other cases, the high-band linear array 440 may not extend along the same axis as the low-band linear array 430. For example, the high-band linear array may extend along a first axis A1 that is between a second axis A2 that is defined by first sides of the low-band radiating elements 432 and a third axis A3 that is defined by second (opposed) sides of the low-band radiating elements 432. The first axis A1 may be parallel to both the second axis A2 and the third axis A3.

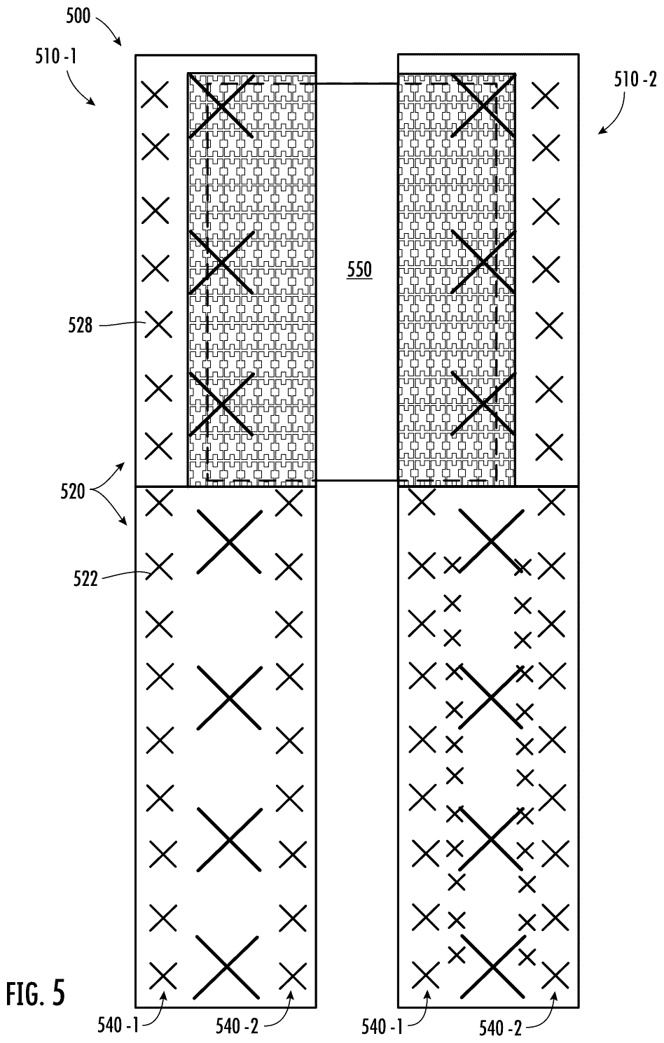

FIG. 5 is a schematic front view of a passive/active antenna system 500 according to further embodiments of the present invention with the radomes of the two passive base station antennas omitted. As the passive/active antenna system 500 is very similar to passive/active antenna system 300 of FIGS. 3A-3F, the description below will focus solely on the differences between the two passive/active antenna systems 300, 500.

As can be seen by comparing FIGS. 3F and 5, the primary difference between passive/active antenna system 300 and passive/active antenna system 500 is that in passive/active antenna system 500 the outer side of the main reflector 522 extends the full length of each passive base station antenna 510-1, 510-2 and the width of the frequency selective surfaces 528 is reduced in each antenna 510 so that the frequency selective surfaces 528 are narrower in the horizontal (width) direction than the frequency selective surfaces 328. This arrangement may provide increased structural support. Since the outer portion of each main reflector 522 is extended, the outer mid-band linear arrays 540 in each passive base station antenna 510 may be extended, which may narrow the elevation beamwidth of the generated antenna beams and increase the gain of these arrays. The length of the inner mid-band linear arrays 540 is not extended in this embodiment, which may allow the frequency selective surface 528 to be designed to have increased reflectivity in the low-band frequency range and increased transmissivity in the high-band frequency range as compared to a frequency selective surface that is designed to reflect both low-band and mid-band radiation while passing high-band radiation. It will be appreciated, however, that in other embodiments the number of radiating elements in the inner mid-band arrays 540 may be increased so that some of the radiating elements in these arrays are mounted forwardly of the frequency selective surface 528. In such embodiments, the frequency selective surface 528 may be designed to reflect both low-band and mid-band radiation while passing high-band radiation.

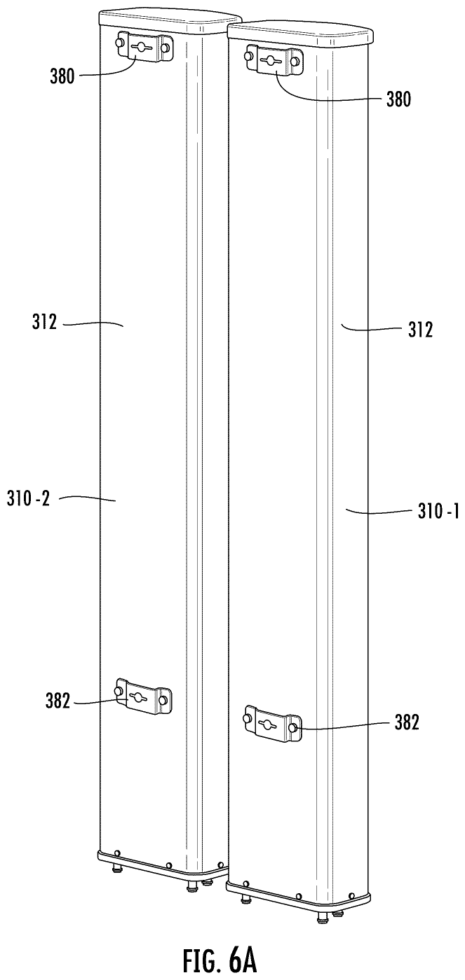

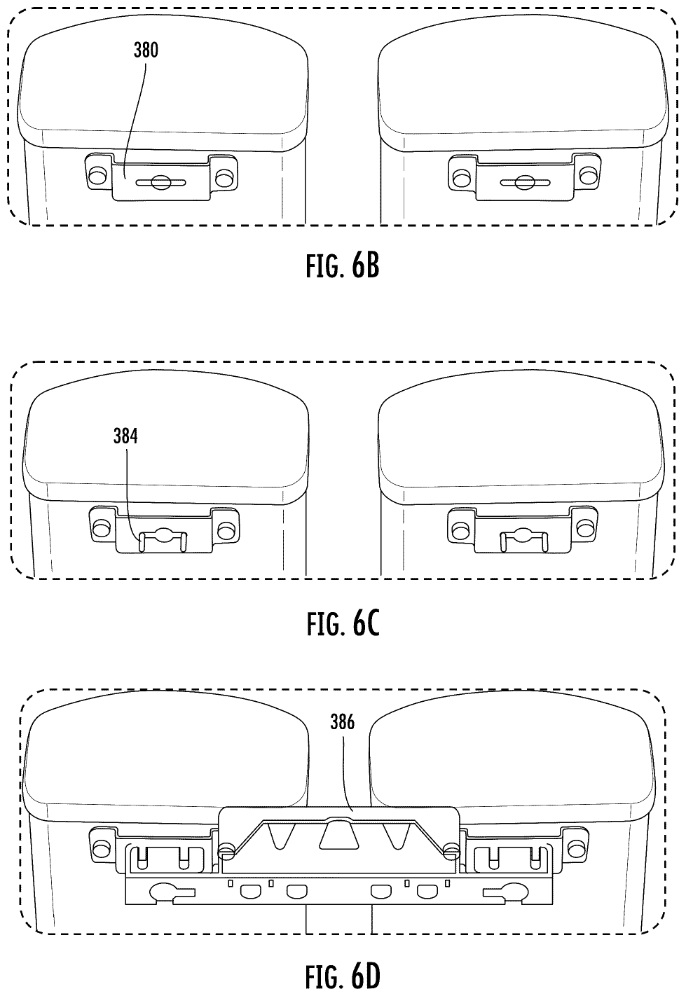

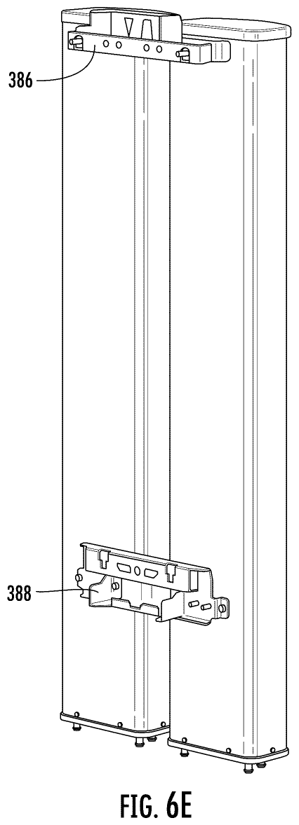

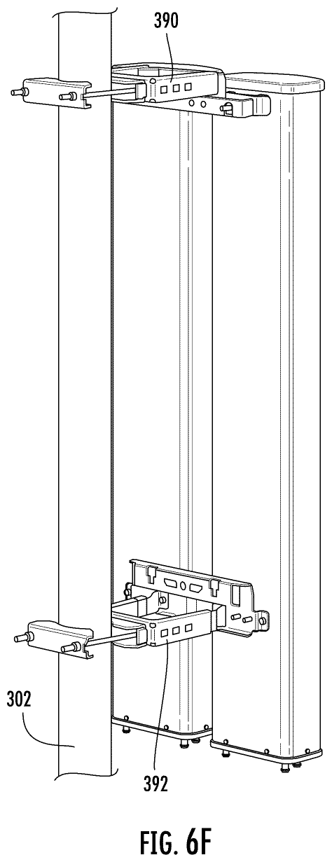

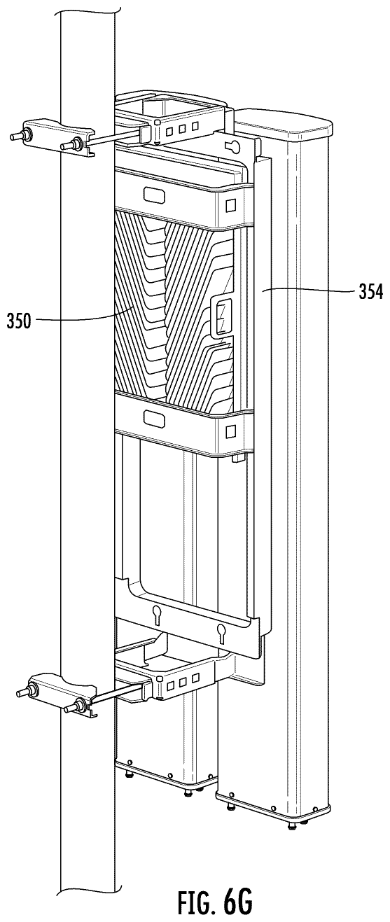

FIGS. 6A-6G are various views illustrating how a passive/active antenna system according to embodiments of the present invention (e.g., passive/active antenna system 300) may be mounted on an antenna tower 302 with the active antenna module 350 thereof mounted on the antenna mounting brackets 304.

Referring to FIG. 6A, the two passive base station antennas 310-1, 310-2 may be provided. Each base station antenna 310 includes an upper mounting plate 380 and a lower mounting plate 382. The mounting plates 380, 382 may extend rearwardly from the back surface of the radomes 312 and may connect to a structural component within the radome 312. FIG. 6B is an enlarged view of the top portion of FIG. 6A that shows an example design for the upper mounting plates 380 in more detail.

Referring to FIG. 6C, bolts 384 may be inserted through openings in each upper mounting plate 380. Referring to FIG. 6D, a shared upper mounting plate 386 may be mounted on the bolts 384 and nuts may be used to affix the shared upper mounting plate 386 onto the upper mounting plates 380 of the first and second passive base station antennas 310-1, 310-2. Referring to FIG. 6E, the same operations may be performed to attach a shared lower mounting plate 388 onto the lower mounting plates 382 of the first and second passive base station antennas 310-1, 310-2.

Referring to FIG. 6E, an upper antenna mounting bracket 390 is mounted on a mounting structure such as an antenna pole 302, and the shared upper mounting plate 386 is affixed to the upper antenna mounting bracket 390 via, for example, nuts and bolts. Similarly, a lower antenna mounting bracket 392 is mounted on the antenna pole 302, and the shared lower mounting plate 388 is affixed to the lower antenna mounting bracket 392 via, for example, nuts and bolts, to mount the first and second passive base station antennas onto the antenna pole 302. Finally, referring to FIG. 6G, the active antenna module 350 may be mounted (e.g., via bolts) onto a mounting frame 354, and the mounting frame 354 may be attached to the upper antenna mounting bracket 390. In some case, the mounting frame 354 may be slidably received on the upper antenna mounting bracket 390 and then bolted into place.

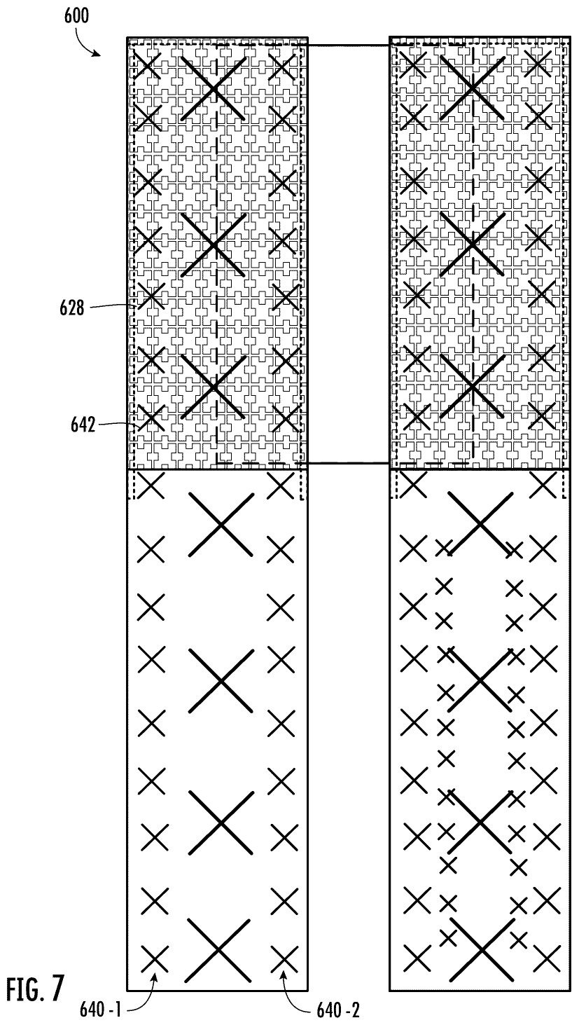

FIG. 7 is a schematic front view of a passive/active antenna system 600 according to still further embodiments of the present invention with the radomes of the two passive base station antennas omitted. The passive/active antenna system 600 is identical to passive/active antenna system 300 except that the mid-band linear arrays 640-1, 640-2 in passive/active antenna system 600 include more radiating elements so that some of the mid-band radiating elements 642 are mounted forwardly of the frequency selective surface 628. Accordingly, the frequency selective surface 628 may be designed to reflect both low-band and mid-band radiation while passing high-band radiation.

Representative embodiments of the present invention are described above. It will be appreciated, however, that embodiments of the present invention are not limited to the above representative embodiments. For example, the two side-by-side passive base station antennas may have any appropriate configuration. In another example embodiment, each of the two side-by-side passive base station antennas may have two low-band arrays instead of one. It will also be appreciated that the active antenna module may have any appropriate multi-column beamforming array including, for example, a frequency division duplex (FDD) mid-band array (e.g., that operates in the 1.7-2.2 GHz frequency band), a time division duplex (TDD) mid-band array (e.g., that operates in the 2.3-2.7 GHz frequency band), a TDD high-band array (e.g., that operates in the 3.3-4.0 GHz frequency band) or a TDD mid/high-band array (e.g., that operates in the 2.3-4.0 GHz frequency band).

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A passive/active antenna system, comprising:
a first passive base station antenna that has a first radome;
a second passive base station antenna that has a second radome, the second passive base station antenna mounted adjacent the first passive base station antenna; and
an active antenna module mounted behind both the first passive base station antenna and the second passive base station antenna and configured to transmit radio frequency (“RF”) signals through both the first passive base station antenna and the second passive base station antenna.

2. The passive/active antenna system of claim 1, wherein the first passive base station antenna is horizontally spaced apart from the second passive base station antenna by a gap, and wherein the active antenna module is also configured to transmit RF signals through the gap.

3. The passive/active antenna system of claim 2, wherein a minimum width of the gap is at least 40 millimeters.

4-5. (canceled)

6. The passive/active antenna system of claim 1, wherein the active antenna module and the first and second passive base station antennas are mounted on a mounting structure using shared mounting hardware.

7. (canceled)

8. The passive/active antenna system of claim 1, wherein the active antenna module overlaps the first passive base station antenna in a forward direction that is perpendicular to a plane defined by a main reflector of the first passive base station antenna, and the active antenna module overlaps the second passive base station antenna in the forward direction.

9. The passive/active antenna system of claim 1,
wherein the first passive base station antenna comprises:
a first reflector;
a first frequency selective surface mounted above the first reflector;
a first plurality of lower-band radiating elements that form a first lower-band array, where a first subset of the first plurality of lower-band radiating elements extend forwardly of the first reflector and a second subset of the first plurality of lower-band radiating elements extend forwardly of the first frequency selective surface, and wherein the second passive base station antenna comprises:
a second reflector;
a second frequency selective surface mounted above the second reflector;
a second plurality of lower-band radiating elements that form a second lower-band array, where a first subset of the second plurality of lower-band radiating elements extend forwardly of the second reflector and a second subset of the second plurality of lower-band radiating elements extend forwardly of the second frequency selective surface.

10. The passive/active antenna system of claim 9, wherein the first and second subsets of the first plurality of lower-band radiating elements extend along a first axis, and the first passive base station antenna further comprises a plurality of higher-band radiating elements that extend along the first axis,
wherein the active antenna module includes a multi-column array of intermediate-band radiating elements, the multi-column array configured to transmit RF signals through both the first passive base station antenna and the second passive base station antenna, where each intermediate-band radiating element has an operating frequency band that is above an operating frequency band of the lower-band radiating elements and that is below an operating frequency band of the higher-band radiating elements, and
wherein the first frequency selective service is mounted on a metal support that includes a meta-surface that is substantially transparent to RF energy in the operating frequency band of the intermediate-band radiating elements.

11-14. (canceled)

15. A passive/active antenna system, comprising:
a first passive base station antenna that has a first housing that includes a first radome;
a second passive base station antenna that has a second housing that includes a second radome mounted adjacent the first passive base station antenna and spaced apart from the first passive base station antenna in a horizontal direction by a gap; and
an active antenna module having a multi-column array of radiating elements mounted so that a first column of radiating elements of the multi-column array is behind the first passive base station antenna, a second column of radiating elements of the multi-column array is behind the second passive base station antenna, and a third column of radiating elements of the multi-column array is at least partly behind the gap.

16. The passive/active antenna system of claim 15, wherein the first and second passive base station antennas are configured to be mounted on a mounting structure, and the active antenna module is configured to be mounted between the first and second passive base station antennas and the mounting structure.

17. The passive/active antenna system of claim 16, wherein the active antenna module is configured to transmit RF signals through the first passive base station antenna, the second passive base station antenna, and the gap.

18. The passive/active antenna system of claim 17, wherein a minimum width of the gap in the horizontal direction is between 20 millimeters and 200 millimeters.

19. The passive/active antenna system of claim 18, wherein the first passive base station antenna includes a frequency selective surface, and the frequency selective surface overlaps the first column of radiating elements of the multi-column array in a forward direction that is perpendicular to both a vertical direction and the horizontal direction.

20. The passive/active antenna system of claim 19, wherein the first frequency selective service is mounted on a metal support that includes a meta-surface that is substantially transparent to RF energy in an operating frequency band of the multi-column array of radiating elements.

21. The passive/active antenna system of claim 19, wherein the first frequency selective service is mounted on a first pair of non-metallic supports and the second frequency selective service is mounted on a second pair of non-metallic supports.

22. The passive/active antenna system of claim 16, wherein the active antenna module is positioned within 50 millimeters of both the first passive base station antenna and the second passive base station antenna.

23. A passive/active antenna system, comprising:
a first passive base station antenna that has a first radome that has a first inner side and a first outer side opposite the first inner side;
a second passive base station antenna that has a second radome that has a second inner side and a second outer side opposite the second inner side, the second base station antenna mounted adjacent the first passive base station antenna in a horizontal direction so that the second inner side is adjacent the first inner side; and
an active antenna module having a multi-column array of radiating elements mounted behind both the first passive base station antenna and the second passive base station antenna, wherein the first passive base station antenna includes a first frequency selective surface that extends closer to the first inner side than it does to the first outer side, and the second passive base station antenna includes a second frequency selective surface that extends closer to the second inner side than it does to the second outer side.

24. The passive/active antenna system of claim 23, wherein the first passive base station antenna is spaced apart from the second passive base station antenna by a gap of at least 20 millimeters.

25. The passive/active antenna system of claim 24, wherein the active antenna module is configured to transmit RF signals through the first frequency selective surface, through the second frequency selective surface, and through the gap.

26. (canceled)

27. The passive/active antenna system of claim 25, wherein a longitudinal axis of the first passive base station antenna extends substantially in a vertical direction and the first passive base station antenna is spaced apart from the second passive base station antenna in the horizontal direction, and the first frequency selective surface overlaps at least a first of the columns of radiating elements in the multi-column array in a forward direction that is perpendicular to both the vertical direction and the horizontal direction, and the second frequency selective surface overlaps at least a second of the columns of radiating elements in the multi-column array in the forward direction.

28. (canceled)

29. The passive/active antenna system of claim 23, wherein the first and second passive base station antennas are configured to be mounted on a mounting structure, and the active antenna module is configured to be mounted between the first and second passive base station antennas and the mounting structure.

30-44. (canceled)
